(19) United States
(12) Patent Application Publication
(10) Pub. No.: US 2024/0246421 A1
(43) Pub. Date: Jul. 25, 2024

(54) Solar Recharging Electric Vehicle and System

(71) Applicant: Lawrence Lapadat, Victoria (CA)

(72) Inventor: Lawrence Lapadat, Victoria (CA)

(21) Appl. No.: 18/406,318

(22) Filed: Jan. 8, 2024

Related U.S. Application Data
(60) Provisional application No. 63/440,775, filed on Jan. 24, 2023.

(51) Int. Cl. B60L 8/00

(52) U.S. Cl. CPC B60L 8/003

(57) ABSTRACT

An electric vehicle solar charging system for recharging the vehicle's main battery using solar energy. The system includes multiple solar panels covered with tempered curved plastic or glass covering the solar panels for protection from physical damage and weather elements wherein each solar panel is connected to a battery charge controller that regulates the amount of current and voltage sent to the integrated battery(s), preventing overcharging, or undercharging of the integrated battery(s). In some embodiments, the system also includes a secondary battery that can be used to provide power to the main battery when solar energy is insufficient. The system can be integrated or retrofitted in an electric vehicle. The solar panels are recessed about ½″ below the car exterior and positioned at an angle that closely follows the angle of the exterior surface of the vehicle.

### CROSS-REFERENCE TO RELATED APPLICATION

The present application claims priority to, and the benefit of, U.S. Provisional Application No. 63/440,775, which was filed on Jan. 24, 2023 and is incorporated herein by reference in its entirety.

### FIELD OF THE INVENTION

The present invention generally relates to the field of electric vehicle systems. More specifically, the present invention relates to a novel solar charging electric vehicle and a solar charging system for electric vehicles and hybrid electric vehicles. The invention can be applied to various types of vehicles, including cars, trucks, trailers, motor homes, and more. A plurality of solar panels positioned on an exterior of the vehicle are used for harnessing the energy of the sun to charge the battery(s) of the vehicle thereby enabling vehicle owners to drive longer amounts of time and longer distances between charges. Accordingly, the present disclosure makes specific reference thereto. Nonetheless, it is to be appreciated that aspects of the present invention are also equally applicable to other like applications, devices, and methods of manufacture.

### BACKGROUND

By way of background, electric vehicles have become popular in the last few years as they are environmentally friendly and reduce the reliance of gasoline and fossil fuels. They do not cause pollution and are cost-effective while in use as well. With their low operating costs, many drivers opt to purchase electric vehicles as a way to save money on fuel costs. However, despite their advantages, the cost and inconvenience of charging electric vehicles can still be a deterrent for some potential buyers.

One of the biggest challenges faced by electric vehicle owners is the issue of charging their electric vehicles. Unlike conventional gasoline-powered vehicles, electric vehicles rely on batteries that are required to be recharged for powering the electric vehicle. The need for frequent charging can be inconvenient for drivers, particularly those who live in apartments or other areas where it is not possible to install a charger. Many apartments do not have chargers which make it difficult and inconvenient for people to charge their electric vehicles.

Further, the process of charging an electric vehicle can be time-consuming, particularly if the battery is completely depleted. While some public charging stations are available, many drivers find that these stations are not always conveniently located or readily available when they need them. This problem is exacerbated on long trips and off-road trips. Also, electric vehicles often require more frequent stops for charging compared to gasoline-powered vehicles and electric vehicle owners may need to stop more frequently to recharge their batteries, which can be disruptive to their daily routines and schedules. People desire an alternative way for charging their electric vehicle battery to overcome charging problems associated with electric vehicles.

Therefore, there exists a long felt need in the art for an alternative system for charging a battery(s) of an electric vehicle. There is also a long felt need in the art for an electric vehicle charging system that enables vehicle owners to drive longer amounts of time and drive longer distances without requiring frequent charges. Additionally, there is a long felt need in the art for a charging system for electric vehicles that keeps charging the electric vehicle without requiring a user to stop at a charging station. Moreover, there is a long felt need in the art for an alternative method for charging an electric vehicle using solar cells that harnesses the energy of the sun to charge the battery of the vehicle. Further, there is a long felt need in the art of an electric vehicle charging system that makes it easier for people to buy electric vehicles by reducing charging problems of electric vehicles. Furthermore, there is a long felt need in the art for an improved charging system for electric vehicles that reduces the cost of electricity required to charge the battery of a vehicle. Finally, there is a long felt need in the art for a charging system and method for electric vehicles that offers a sustainable and convenient solution to charging electric vehicles using solar panels.

The subject matter disclosed and claimed herein, in one embodiment thereof, comprises a solar recharging electric vehicle. The vehicle further comprising an electric vehicle with an integrated battery, a plurality of solar panels positioned on an exterior surface of the electric vehicle, wherein each of the solar panels includes a plurality of weather resistant photovoltaic cells configured to absorb solar energy and convert it into electric power for recharging the integrated battery, an internal circuit wiring the solar panels to the integrated battery, a secondary battery coupled to the solar panels for storing electric power generated by the solar cells when the integrated battery is fully charged, wherein the solar panels are recessed (i.e., about ½″) below the car exterior and positioned at an angle that closely follows the angle of the exterior surface of the vehicle, for reducing drag and maximizing their exposure to sunlight throughout the day. The vehicle has a charge controller for preventing overcharging and undercharging of the integrated battery.

In this manner, the solar recharging electric vehicle of the present invention accomplishes all of the forgoing objectives and provides users with an alternative method for charging an electric vehicle using solar cells. The vehicle and associated system harness the energy of the sun to charge the battery of the vehicle and enable vehicle owners to go longer amounts of time and distance between charges.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar recharging electric vehicle. The vehicle further comprising an electric vehicle with an integrated battery, a plurality of solar panels positioned on an exterior surface of the electric vehicle, wherein each of the solar panels includes a plurality of weather resistant photovoltaic cells configured to absorb solar energy and convert it into electric power for recharging the integrated battery, an internal circuit wiring the solar panels to the integrated battery, a secondary battery coupled to the solar panels for storing electric power generated by the solar cells when the integrated battery is fully charged, wherein the solar panels are recessed within the body panels of the electric vehicle, for example about ½″, below the car exterior and positioned at an angle that closely follows the angle of the exterior surface of the vehicle, for reducing drag and maximizing their exposure to sunlight throughout the day.

In yet another embodiment, an electric vehicle solar charging system is disclosed. The system comprising a plurality of solar panels positioned on an exterior surface of the electric vehicle, an integrated battery configured to store electric power generated by the solar panels, a battery charge controller connected to the solar panels and the integrated battery, wherein the battery charge controller is configured to prevent overcharging or undercharging of the integrated battery by regulating the amount of current and voltage sent from the solar panels to the battery, and wherein the battery charge controller is configured to monitor the state of the battery and adjust the charging current and voltage, a secondary battery connected to the solar panels and configured to store electric power generated by the solar panels in cases where the integrated battery is fully charged.

In a further embodiment, a method for recharging an electric vehicle battery using solar panels installed on an exterior of the vehicle is described. The method comprising the steps of installing solar panels on the vehicle, connecting the solar panels with integrated or main battery of the vehicle and a secondary battery, comparing the power level of the main battery with a preconfigured or predetermined threshold, if the power level is above the preconfigured or predetermined threshold, then not using the solar panels for recharging the vehicle battery, if the power level is below the preconfigured or predetermined threshold, then comparing the DC current power or level produced by the solar panels with a second threshold, wherein the second threshold indicates the minimum current level for safe charging of the vehicle battery, if the DC current power is above the second threshold, then directly charging the vehicle battery with the DC current of the solar panels and if the DC current power is determined to be below the second threshold, then recharging the main battery using power from the secondary battery.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a solar recharging electric vehicle of the present invention in accordance with the disclosed architecture;

FIG. 2 illustrates a detailed functional block diagram of the solar charging system used in the solar recharging electric vehicle of FIG. 1 in accordance with the disclosed architecture;

FIG. 3 illustrates a flow diagram depicting a process of installing solar panels on an electric vehicle and recharging the main battery of the electric vehicle in accordance with the disclosed architecture;

FIG. 4 illustrates a flow chart depicting a process of charging the main battery of the electric vehicle based on power level of main battery and electric current strength of the solar panels in accordance with the disclosed architecture; and

FIG. 5 illustrates a cross-sectional view of an exemplary solar panel installed in exterior of the electric vehicle of FIG. 1 in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an alternative system for charging battery(s) of an electric vehicle. There is also a long felt need in the art for an electric vehicle charging system that enables vehicle owners to drive longer amounts of time and drive longer distances without requiring frequent charges. Additionally, there is a long felt need in the art for a charging system for electric vehicles that keeps charging the electric vehicle without requiring a user to stop at a charging station. Moreover, there is a long felt need in the art for an alternative method for charging an electric vehicle using solar cells that harnesses the energy of the sun to charge the battery of the vehicle. Further, there is a long felt need in the art of an electric vehicle charging system that makes it easier for people to buy electric vehicles by reducing charging problems of electric vehicles. Furthermore, there is a long felt need in the art for an improved charging system for electric vehicles that reduces the cost of electricity required to charge the battery of a vehicle. Finally, there is a long felt need in the art for a charging system and method for electric vehicle that offers a sustainable and convenient solution to charging electric vehicles using solar panels.

The present invention, in one exemplary embodiment, is an electric vehicle solar charging system. The system features a plurality of solar panels disposed in an exterior of the electric vehicle, an integrated battery configured to store electric power generated by the solar panels, a battery charge controller connected to the solar panels and the integrated battery, wherein the battery charge controller is configured to prevent overcharging or undercharging of the integrated battery by regulating the amount of current and voltage sent from the solar panels to the battery, and wherein the battery charge controller is configured to monitor the state of the battery and adjust the charging current and voltage, a secondary battery connected to the solar panels and configured to store electric power generated by the solar panels in cases where the integrated battery is fully charged.

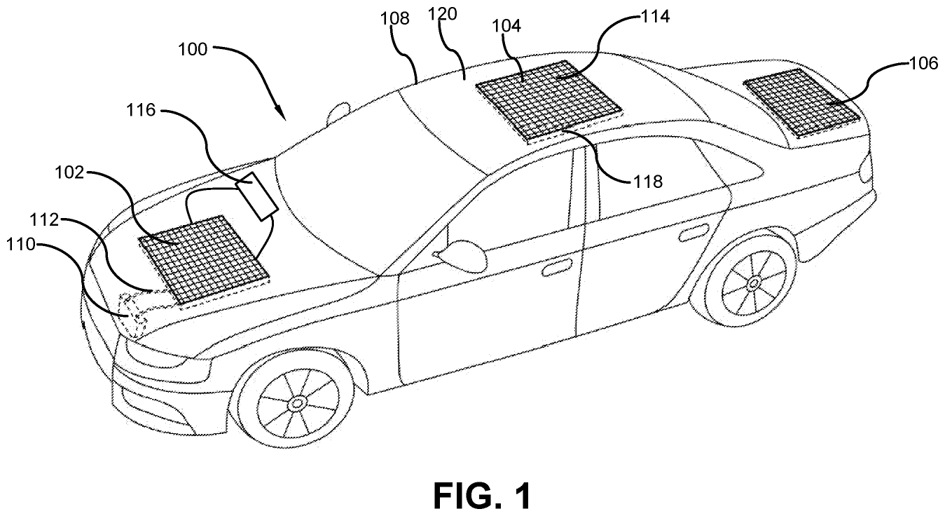

Referring initially to the drawings, FIG. 1 illustrates a perspective view of one potential embodiment of a solar recharging electric vehicle of the present invention in accordance with the disclosed architecture. The solar recharging electric vehicle 100 of the present invention is designed to provide an alternative method of charging built-in battery using solar panels enabling vehicle owners to go longer distances without requiring charges. More specifically, the vehicle 100 has a plurality of solar panels 102, 104, 106 positioned on an exterior surface 108 of the electric vehicle 100. Based on the design of the vehicle, the solar panels can be appropriately positioned enabling solar energy to directly fall on the solar panels.

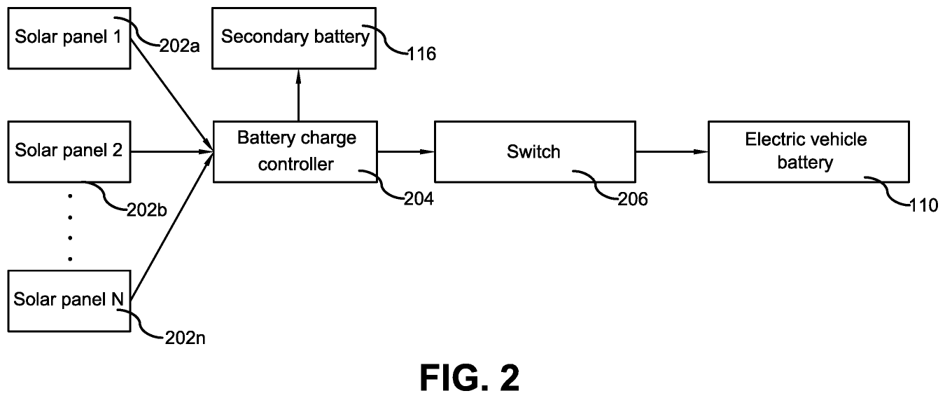

The solar panels 102, 104, 106 are internally wired to integrated or built-in battery 110 of the electric vehicle 100 through internal circuit 112. In FIG. 1, solar panel 102 is shown to be connected to the primary battery 110 for simple illustration but internally all solar panels 102, 104, 106 are wired to the integrated or main or primary battery 110. The solar panels 102, 104, 106 are made of a plurality of weather resistant photovoltaic cells 114 and are configured to absorb solar energy and convert same into electric power for recharging main or primary battery 110. For providing effective charging and preventing overheating of the main or primary battery 110, the solar panels 102, 104, 106 are also coupled (i.e., internally wired) to an auxiliary or secondary battery 116 as illustrated in FIGS. 1 and 2. The auxiliary or secondary battery 116 is configured to store electric power generated by the solar cells 102, 104, 106 in cases where the main or primary battery 110 is fully charged as described later in the disclosure.

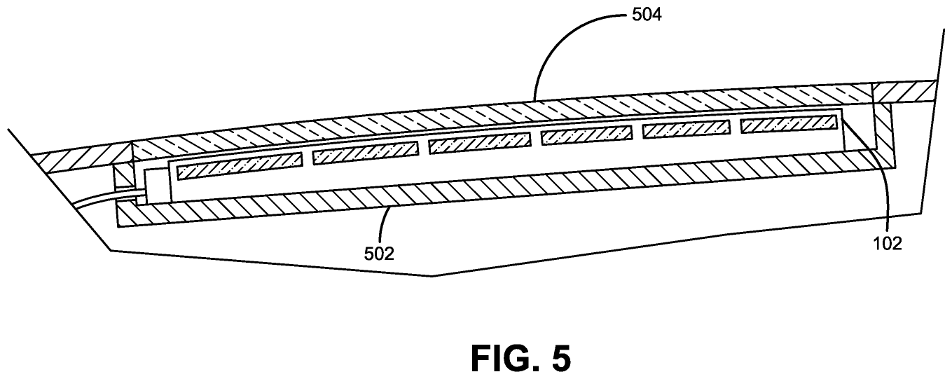

The solar panels 102, 104, 106 are made of semiconductor materials, such as silicon, that have the ability to absorb photons of sunlight and release electrons, which are then collected by the internal electrical circuit 112. In the preferred embodiment, the solar panels 102, 104, 106 are mounted on the exterior of the vehicle 100 as illustrated in FIG. 1 and are recessed, for example, about ½″ 118 below the car exterior 108 (i.e., recessed within the body panels of the vehicle), using tempered curved glass or plastic to protect the cells from damage as illustrated in FIG. 5.

One advantage of solar panels 102, 104, 106 used in the vehicle 100 is that they are designed such that photovoltaic cells 114 of the solar panels are set an angles that closely follows the angles (i.e., aligned with the angles) and contours of the exterior surfaces and body panels of the vehicle 100 on which the solar panels are positioned. Thus, the angle of solar panel 102 aligns with and models the angle and contour of a hood of the vehicle. The angle of solar panel 104 aligns with and models the angle and contour of a roof of the vehicle. The angle of solar panel 106 aligns with and models the angle and contour of a trunk of the vehicle. This helps in reducing drag and ensuring that the panels 102, 104, 106 are as perpendicular to the sun as possible, enabling them to absorb the maximum amount of sunlight throughout the day. For example, the solar panel 104 positioned on roof 120 of the vehicle 100 have photovoltaic cells oriented in the range from about 45 degrees to about 60 degrees relative to horizontal for effective absorption of the solar energy.

FIG. 2 illustrates a detailed functional block diagram of the solar charging system used in the solar recharging electric vehicle of FIG. 1 in accordance with the disclosed architecture. It should be noted that that for illustrations, three solar panels 102, 104, 106 are shown in FIG. 1. Depending on the design of the vehicle, any number of solar panels of different sizes and shapes can be positioned on the vehicle for effective solar energy absorption. As illustrated in the present embodiment, a plurality of solar panels 202a-n are used in the electric vehicle solar charging system 200 which are connected to a battery charge controller 204. The battery charge controller 204 is configured to prevent overcharging or undercharging of the main or primary battery 110. The battery charge controller 204 regulates the amount of current and voltage sent from the solar panels 202a-n to the primary battery 110. The battery charge controller 204 is configured to monitor the state of the primary battery 110 and adjusts the charging current and voltage accordingly and further can switch off supply to the primary battery 110 using the switch 206.

In some embodiments, when the power level of the primary battery 110 is low, preferably less than 50% of total power level of the primary battery 110, the charge controller 204 allows the maximum amount of current and voltage from the solar panels 202a-n to charge the primary battery 110. When the power level of the primary battery 110 is fully charged, the charge controller 204 disables supply to the primary battery 110 and can start recharging the auxiliary or secondary battery 116. The auxiliary or secondary battery 116 can be used for providing electric power to the main or primary battery 110 in cases when solar energy is not sufficient and the power level of the primary battery 110 is low to provide electric power to the vehicle.

In some embodiments of the present invention, when the charge controller 204 determines the power level of the primary battery 110 is at least 90% of the total power level of the primary battery 110, then, the charge controller 204 reduces the amount of current and voltage sent to the primary battery 110 and increases the amount of current and voltage sent to the secondary battery 116.

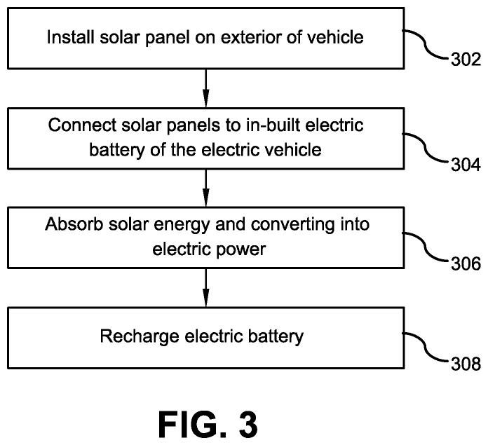

FIG. 3 illustrates a flow diagram depicting a process of installing solar panels on an electric vehicle and recharging the main battery of the electric vehicle in accordance with the disclosed architecture. Initially, solar panels are installed on exterior of the electric vehicle (Step 302). The solar panels can be retrofitted or can be integrated into the vehicle during manufacturing of the vehicle. Then, the solar panels are connected to built-in electric battery 110 of the vehicle as illustrated in FIGS. 1 and 2 (Step 304). It should be noted that the connection of the primary battery 110 and the solar panels does not impact any other electrical connection of the vehicle.

Thereafter, the solar panels absorb solar energy and photovoltaic cells convert solar energy into electrical power which is transmitted to the battery charge controller as illustrated in FIG. 2 (Step 306). Finally, the primary battery 110 is recharged using electric power generated by the solar panels for effective and continuous recharging (Step 308).

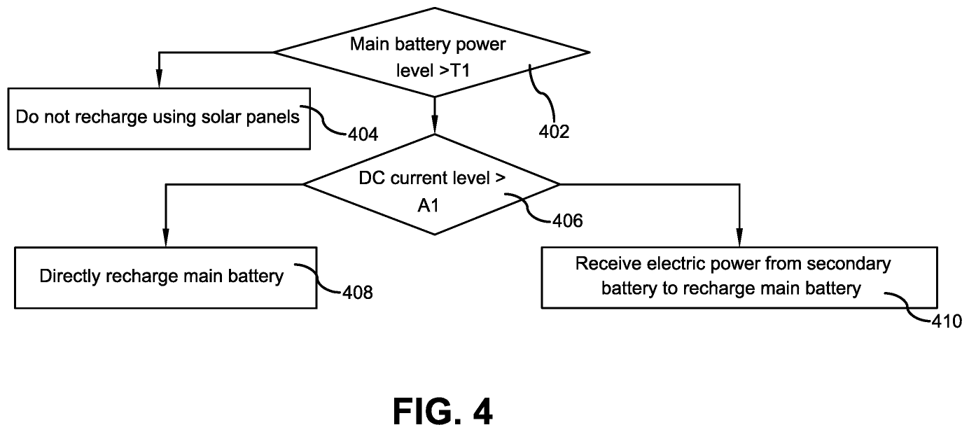

FIG. 4 illustrates a flow chart depicting a process of charging the main battery of the electric vehicle based on power level of main battery and electric current strength of the solar panels in accordance with the disclosed architecture. For recharging the main or primary battery 110 of the electric vehicle, power level of main or primary battery 110 of the vehicle is compared with a preconfigured or predetermined threshold “T1” (Step 402). The comparison can be performed by the battery charge controller 204. If the power level is above “T1”, then the solar panels are not used for recharging the vehicle battery 110 (Step 404). This is for preventing overheating or overcharging of the vehicle battery 110.

If the power level is below “T1”, then power or level of the DC current produced by the solar panels is compared with a second threshold “A1” (Step 406). Threshold “A1” indicates minimum current level for safe charging of the vehicle battery 110. If the DC current power is above second threshold “A1”, then the vehicle battery 110 is directly charged with DC current of the solar panels as illustrated in FIG. 2 (Step 408). Further, if the DC current power is determined to be below second threshold “A1”, then main or primary battery 110 is recharged using the power from the auxiliary or secondary battery 116 (Step 410).

FIG. 5 illustrates a cross-sectional view of an exemplary solar panel installed in exterior of the electric vehicle of FIG. 1 in accordance with the disclosed architecture. The solar panel 102 is shown as an example in the present embodiment and is positioned in a recess 502 which is disposed in exterior of the vehicle for secure positioning. Further, the solar panel 102 can have a connector 504 for connecting the solar panel 102 to one or more batteries of the vehicle. The recess 502 is preferably about 1/2 ″ under the exterior surface of the vehicle, however the depth of the recess can depend on the design and type of the vehicle. A tempered curved plastic or glass 504 is disposed to cover the solar panel 102 for protection from physical damage and weather elements. The glass 504 does not obstruct the solar light and thus does not decrease efficiency of the solar panel 102. As described earlier, photovoltaic cells of the solar panels are set at an angle closely following the angles and contours of the vehicle to maximize their exposure to sunlight throughout the day.

It should be noted that the present invention can be used for manufacturing or modifying any type of vehicle by applying solar cell panels over the exterior of a vehicle, such as a car, truck, trailer, or motorhome.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar recharging electric vehicle”, “electric vehicle”, “vehicle”, and “solar panels integrated electric vehicle” are interchangeable and refer to the solar recharging electric vehicle 100 of the present invention. Similarly, as used herein “electric vehicle solar charging system”, “solar charging system”, and “system” are interchangeable and refer to the electric vehicle solar charging system 200 of the present invention.

Notwithstanding the forgoing, the solar recharging electric vehicle 100 and the electric vehicle solar charging system 200 of the present invention can be of any suitable size and configuration as is known in the art without affecting the overall concept of the invention, provided that it accomplishes the above stated objectives. One of ordinary skill in the art will appreciate that the solar recharging electric vehicle 100 and the electric vehicle solar charging system 200 as shown in the FIGS. are for illustrative purposes only, and that many other sizes and shapes of the solar recharging electric vehicle 100 and the electric vehicle solar charging system 200 are well within the scope of the present disclosure. Although the dimensions of the solar recharging electric vehicle 100 and the electric vehicle solar charging system 200 are important design parameters for user convenience, the solar recharging electric vehicle 100 and the electric vehicle solar charging system 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar recharging electric vehicle comprising:
an electric vehicle having a plurality of solar panels mounted onto an exterior of the electric vehicle;
wherein said plurality of solar panels receiving solar energy for charging a primary battery and a secondary battery for extending the range of the electric vehicle;
wherein said plurality of solar panels internally wired to said primary battery of the electric vehicle through an internal circuit;
wherein said primary battery is a main battery of the electric vehicle;
wherein said plurality of solar panels internally wired to said secondary battery of the electric vehicle;
wherein said charging said secondary battery is after fully charging said primary battery; and
further wherein said plurality of solar panels recessed in body panels of the electric vehicle.

2. The solar recharging electric vehicle of claim 1, wherein each of said plurality of solar panels having a curved glass protective cover.

3. The solar recharging electric vehicle of claim 2, wherein said body panels of the electric vehicle having a first angle relative to the sun and said plurality of solar panels having a second angle relative to the sun, and further wherein said first angle aligned with said second angle.

4. The solar recharging electric vehicle of claim 3, wherein said body panels of the electric vehicle having a first contour and said plurality of solar panels having a second contour, and further wherein said first contour aligned with said second contour.

5. The solar recharging electric vehicle of claim 4, wherein said plurality of solar panels include at least a first solar panel aligning with and modeling an angle and a contour of a hood of the electric vehicle.

6. The solar recharging electric vehicle of claim 5, wherein said plurality of solar panels include at least a second solar panel aligning with and modeling an angle and a contour of a roof of the electric vehicle.

7. The solar recharging electric vehicle of claim 6, wherein said plurality of solar panels include at least a third solar panel aligning with and modeling an angle and a contour of a trunk of the electric vehicle.

8. The solar recharging electric vehicle of claim 7, wherein said plurality of solar panels having weather resistant photovoltaic cells.

9. A method of recharging batteries in an electric vehicle, the method comprising the steps of:
providing an electric vehicle with a plurality of solar panels mounted onto an exterior of the electric vehicle, wherein said plurality of solar panels receiving solar energy for charging a primary battery and a secondary battery for extending the range of the electric vehicle;
wiring said plurality of solar panels to said primary battery and said secondary battery of the electric vehicle through an internal circuit;
connecting a battery charge controller and a switch to said plurality of solar panels;
regulating through said battery charge controller an amount of current and voltage sent from said plurality of solar panels to said primary battery;
monitoring a state of said primary battery;
adjusting the current and the voltage from said plurality of solar panels to said primary battery based on a power level of said primary battery; and
switching the current and the voltage from said primary battery to said secondary battery when the power level of said primary battery is above a predetermined threshold power level.

10. The method of recharging batteries in an electric vehicle of claim 9, wherein said predetermined threshold power level is 90%.

11. The method of recharging batteries in an electric vehicle of claim 9 further comprising the step of supplying power from said secondary battery to said primary battery when the power level of said primary battery is low.

12. The method of recharging batteries in an electric vehicle of claim 11, wherein said primary battery is a main battery of the electric vehicle, and further wherein said charging said secondary battery is after fully charging said primary battery.

13. The method of recharging batteries in an electric vehicle of claim 12, wherein said plurality of solar panels recessed in body panels of the electric vehicle.

14. The method of recharging batteries in an electric vehicle of claim 13, wherein said body panels of the electric vehicle having a first angle relative to the sun and said plurality of solar panels having a second angle relative to the sun, and further wherein said first angle aligned with said second angle.

15. The method of recharging batteries in an electric vehicle of claim 14, wherein said body panels of the electric vehicle having a first contour and said plurality of solar panels having a second contour, and further wherein said first contour aligned with said second contour.

16. A method of recharging batteries in an electric vehicle, the method comprising the steps of:
providing an electric vehicle with a plurality of solar panels mounted onto an exterior of the electric vehicle, wherein said plurality of solar panels receiving solar energy for charging a primary battery and a secondary battery for extending the range of the electric vehicle;
wiring said plurality of solar panels to said primary battery and said secondary battery of the electric vehicle through an internal circuit;
connecting a battery charge controller and a switch to said plurality of solar panels;
regulating through said battery charge controller an amount of current and voltage sent from said plurality of solar panels to said primary battery;
monitoring a power level of said primary battery;
comparing said power level of said primary battery with a first predetermined threshold power level;
stopping the charge from said plurality of solar panels to said primary battery when said power level exceeds said first predetermined threshold power level;
comparing said power level of said primary battery with a second predetermined threshold power level; and
charging said primary battery with said secondary battery when said power level of said primary battery is below said second predetermined threshold power level.

17. The method of recharging batteries in an electric vehicle of claim 16 further comprising the step of switching the current and the voltage from said primary battery to said secondary battery when said power level of said primary battery is above said first predetermined threshold power level.

18. The method of recharging batteries in an electric vehicle of claim 17, wherein said primary battery is a main battery of the electric vehicle, and further wherein said charging said secondary battery is after fully charging said primary battery.

19. The method of recharging batteries in an electric vehicle of claim 18 wherein said body panels of the electric vehicle having a first angle relative to the sun and said plurality of solar panels having a second angle relative to the sun, and further wherein said first angle aligned with said second angle.

20. The method of recharging batteries in an electric vehicle of claim 19, wherein said body panels of the electric vehicle having a first contour and said plurality of solar panels having a second contour, and further wherein said first contour aligned with said second contour.
